(19) United States
(12) Patent Application Publication
(10) Pub. No.: US 2022/0307540 A1
(43) Pub. Date: Sep. 29, 2022

(54) FASTENING FIXTURE

(71) Applicant: Erik Durr, Dana Point, CA (US)

(72) Inventor: Erik Durr, Dana Point, CA (US)

(21) Appl. No.: 17/656,616

(22) Filed: Mar. 25, 2022

Related U.S. Application Data
(60) Provisional application No. 63/165,826, filed on Mar. 25, 2021.

(51) Int. Cl. F16B 37/06; F16B 37/08

(52) U.S. Cl. CPC F16B 37/065; F16B 37/0807

(57) ABSTRACT

Disclosed are systems and methods for attaching interior furnishings in a vehicle. In one embodiment, a system can include an anchor having a rivet nut, a bolt for engaging the rivet nut, and a railing that can be fastened to the anchor with the bolt. In certain embodiments, the anchor can include a main plate having a rivet nut, a backer plate having press nuts, and screws suitably configured to engage the press nuts and facilitate a movement of the backer plate towards the main plate. In some embodiments, the anchor is configured to fit into and removably attach to a factory cutout of a wall of the vehicle.

### FIELD

Embodiments of the invention relate generally to systems for facilitating fastening of objects. In particular, embodiments of the invention are directed to clamping assemblies that can be used to fasten objects such as interior furnishings in a vehicle.

### BACKGROUND

It is known to provide van interior furnishing kits. Installation of such kits usually require drilling and complex cutting of materials to fit the interior contours of a vehicle, such as a van. Some kits require undesirable, permanent modification of the vehicle.

There is a need in the relevant technology for systems that are removable and facilitate installation of vehicle interior furnishings without cumbersome and/or permanent alterations of the vehicle. Furthermore there is a continuing need for systems that facilitate quick installation of van interiors by do-it-yourselfers. Embodiments of the invention disclosed here satisfy these and other needs.

### SUMMARY OF THE INVENTION

In one aspect, the invention is directed to an anchor assembly having a main plate; a backer plate operatively coupled to the main plate; a press nut coupled to the backer plate; a rivet nut; at least one screw for engaging the press nut and actuating the backer plate to move toward the main plate to thereby facilitate the clamping of an object between the main plate and the backer plate; the main plate can include a rivet orifice configured to receive and retain the rivet nut; the main plate can include a screw orifice configured to allow the screw to pass there through; the backer plate can have a rivet opening configured to allow the rivet nut to pass there through; and the backer plate can have a screw opening configured to allow the at least one screw to pass there through and to engage with the press nut.

In one embodiment, the anchor can be configured to facilitate placing the anchor assembly in a cutout of a wall of a vehicle. In some embodiments, the cutout of the wall of the vehicle comprises a factory cutout.

Another aspect of the invention is concerned with a method of facilitating the attachment of interior furnishings in a vehicle. The method can include the steps of providing an anchor assembly having a main plate; a backer plate operatively coupled to the main plate; at least one press nut coupled to the backer plate; a rivet nut; at least one screw for engaging the press nut and actuating the backer plate to move toward the main plate to thereby facilitate the clamping of an object between the main plate and the backer plate; the main plate can include a rivet orifice configured to receive and retain the rivet nut; the main plate can have at least one screw orifice configured to allow the at least one screw to pass there through; the backer plate can include a rivet opening configured to allow the rivet nut to pass there through; the backer plate can have at least one screw opening configured to allow the at least one screw to pass there through and to engage with the at least one press nut. The method can also include the steps of providing a railing having at least one railing hole configured to allow a bolt to pass there through; providing a bolt; placing the anchor in a cutout of a wall of the vehicle, wherein the main plate is placed on a first side of the wall of the vehicle and the backer plate is placed on a second side of the wall of the vehicle that is opposite to said first side; clamping the anchor to the wall of the vehicle by tightening the at least one screw and actuating the backer plate to move towards the main plate; inserting the bolt through the at least one railing hole and engaging the bolt with the rivet nut; and tightening the bolt to secure the railing to the anchor assembly.

In some embodiments, the method can further involve providing hardware configured to facilitate attaching furnishings to the at least one railing. In certain embodiments, the wall cutout of a vehicle is a factory cutout so that attaching furnishings to the interior of the vehicle does not require making cutouts in the wall of the vehicle.

Yet another aspect of the invention relates to an anchor assembly having a main plate. The main plate can include a main plate rivet hole configured to receive and retain a rivet nut; two main plate screw holes configured to allow screws to pass there through. The anchor assembly can further include a backer plate having a backer plate rivet hole configured to allow a rivet nut to pass there through; and two backer plate screw holes configured to allow screws to pass there through. The anchor assembly can also include two press nuts coupled to the backer plate, each press nut aligned with a backer plate screw hole; a rivet nut placed and retained in the main plate rivet hole, the rivet nut further passing through the backer plate rivet hole; and two screws configured to pass through the two main plate screw holes and the two backer plate screw holes, the two screws further configured to engage the press nuts and to facilitate moving the backer plate toward the main plate to thereby facilitate the clamping of an object between the main plate and the backer plate.

In one embodiment, the anchor assembly can be configured to clamp to a factory cutout of a wall of a vehicle. In some embodiments, the anchor assembly can include a bolt configured to engage with the rivet nut. In certain embodiments, the anchor assembly can include a railing, wherein the railing comprises a hole configured to receive the bolt.

Yet another aspect of the invention is directed to a system for facilitating the attachment of interior furnishings in a vehicle. The system can include an anchor configured to removably couple to a wall of a vehicle. The anchor can include a rivet nut; and a bolt configured to engage with the rivet nut. The system can include a railing having a bolt hole to allow the bolt to pass there through. In one embodiment, the anchor can further include a main plate for supporting the rivet nut. In some embodiments, the anchor further comprises a backer plate configured to cooperate with the main plate to clamp the wall of the vehicle between the main plate and the backer plate. In certain embodiments, the anchor can include press nuts coupled to the backer plate. In one embodiment, the system can further include screws configured to engage with the press nuts. In some embodiments, the anchor is configured to be placed in a factory cutout of the wall of the vehicle so that installation of the interior furnishings does not require making cutouts in the wall of the vehicle. In certain embodiments, the system can include hardware configured to facilitate the attachment of furnishings to the railing.

Another aspect of the invention concerns a method of attaching furnishings to an interior of a vehicle. In one embodiment, the method can include providing an anchor configured to removably couple to a wall of the vehicle using a factory cutout of said wall, wherein a coupling of the anchor to said wall does not require modifications to the wall; coupling a railing to the anchor, wherein the railing is configured to be removably coupled to the anchor; coupling a bracket to the railing, wherein the bracket is configured to be removably coupled to the railing; providing a shelf; wherein the bracket is further configured to receive and removably retain the shelf; providing at least one panel of a cabinet; and coupling the shelf to the at least one panel, wherein the at least one panel is configured to be removably coupled to the shelf. In some embodiments, the anchor can include a main plate and a backer plate, and the anchor can be configured to clamp said wall between the main plate and the backer plate. In certain embodiments, the main plate can be configured to receive and retain a rivet nut.

Additional features and advantages of the embodiments disclosed herein will be set forth in the detailed description that follows, and in part will be clear to those skilled in the art from that description or recognized by practicing the embodiments described herein, including the detailed description which follows, the claims, as well as the appended drawings.

Both the foregoing general description and the following detailed description present embodiments intended to provide an overview or framework for understanding the nature and character of the embodiments disclosed herein. The accompanying drawings are included to provide further understanding and are incorporated into and constitute a part of this specification. The drawings illustrate various embodiments of the disclosure, and together with the description explain the principles and operations thereof.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 is a perspective view of an anchor (or fastening fixture) according to an embodiment of the invention.

FIG. 2 is a front plan view of the anchor of FIG. 1.

FIG. 3 is a perspective view of the anchor of FIG. 1 in use with a rail according to one embodiment of the invention.

FIG. 4 is a cross-sectional view of the anchor of FIG. 1 in use with a wall of a vehicle according to one embodiment of the invention.

FIG. 5 is another cross-sectional view of the anchor of FIG. 4, illustrating the anchor clamped to a vehicle wall according to one embodiment of the invention.

FIG. 6 is a perspective, cross-sectional view of the anchor of FIG. 3 in an exemplary use with a wall paneling of a vehicle, according to one embodiment of the invention.

FIG. 7 is another perspective, cross-sectional view of the anchor of FIG. 6.

FIG. 8 is a perspective, partial cross-sectional view of the anchor of FIG. 3 in use with a support bracket and a shelf, according to one embodiment of the invention.

FIG. 9 is another perspective view of the anchor of FIG. 8.

### DETAILED DESCRIPTION

The specific details of the single embodiment or variety of embodiments described herein are set forth in this application. Any specific details of the embodiments are used for demonstration purposes only, and no unnecessary limitation or inferences are to be understood therefrom.

Before describing in detail exemplary embodiments, it is noted that the embodiments reside primarily in combinations of components related to the system. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In one embodiment, a fastening system can include (a) an anchor configured to be placed into a factory cutout of a van interior wall; (b) screws for securing the anchor to the van interior wall; (c) a wall paneling (with oval cutouts) for placing against the van interior; (d) a railing with bolt holes that attaches to the anchor with bolts and facilitates clamping of the wall paneling to the van wall; and (e) t-slot framing and/or railing hardware (for example, 80/20 aluminum hardware) and/or custom wooden clamp tabs for hanging and securing cabinets to the railing.

In one embodiment, the anchor can be made of metal plates, which can be either laser cut or stamped. In use, according to some embodiments, the anchor can be placed into a factory oval shaped hole, for example. The screws can be tightened until the anchor is secured to the van wall. A rivet nut can be secured to the oval hole using the screws with corresponding press nuts attached to a backer plate. The screws can be tightened to clamp the anchor to the sheet metal factory van hole. The screws provide a clamping force that secures the anchor to the oval factory van hole.

The rivet nut can be secured to the plates and expanded to hold the anchor together. The press nuts are pressed into the backing sheet. The screws can be loosely screwed into the press nuts to consolidate the entire anchor into one assembly.

The wall paneling and rail can then be secured to the anchor. Cabinets can be hung on the rails using known hardware and/or custom wooden tab clamps.

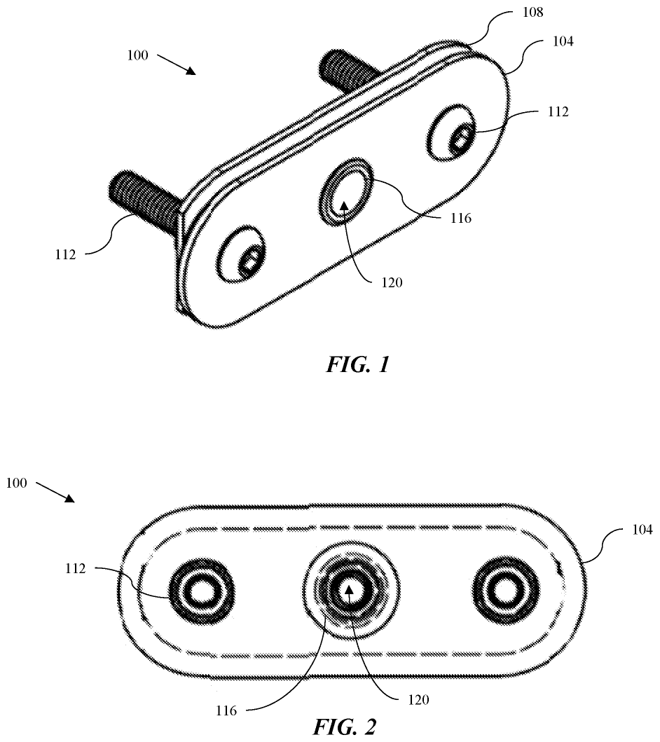

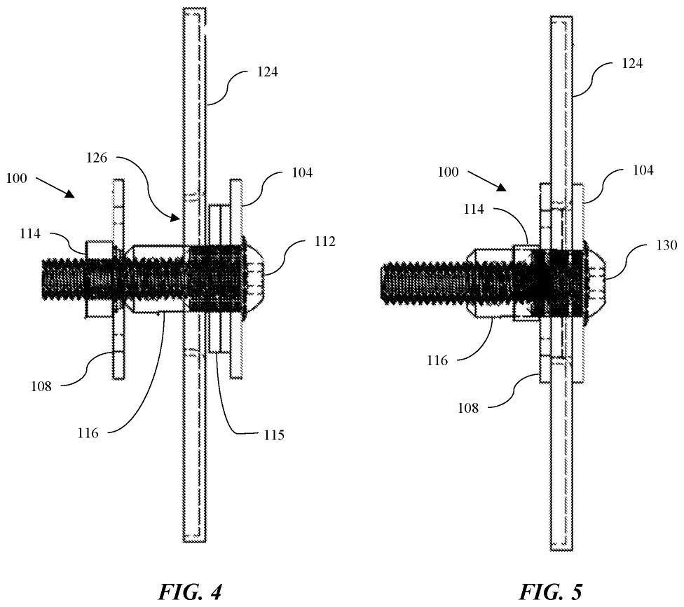

Referencing FIG. 1 through FIG. 3, in one embodiment anchor 100 can include main plate 104 and backer plate 108. Main plate 104 and backer plate 108 can be made of suitable materials such as metal, wood, plastic, and/or composites. Anchor 100 can be secured to, for example, a vehicle wall 124 (FIG. 4, FIG. 5) by screws 112 and press in nuts 114. In some embodiments, screws 112 are machine screws. Main plate 104 can include orifice 120, which orifice 120 can be configured to, among other things, receive and retain rivet nut 116. In some embodiments, main plate 104 can include main plate orifices 110 configured to allow screws 112 to pass through.

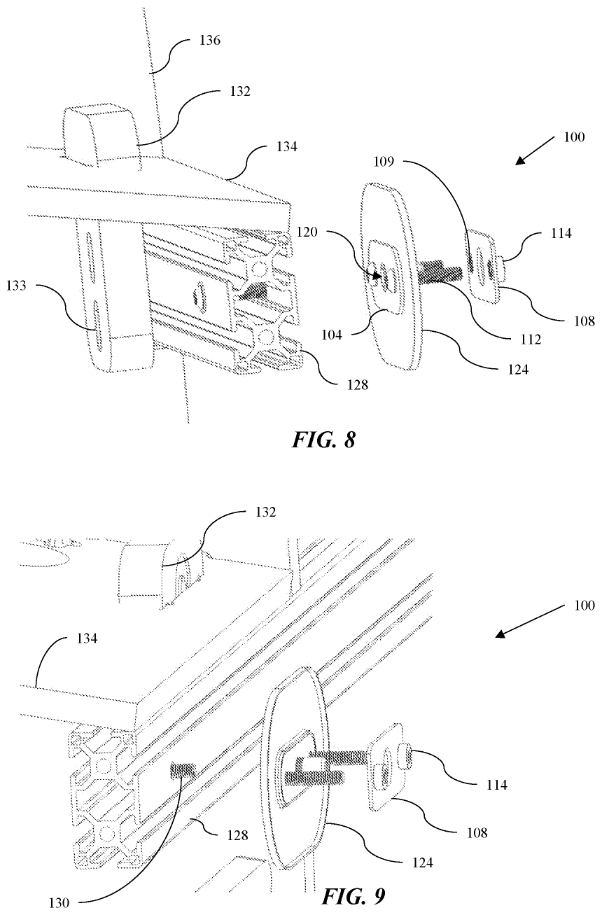

Referencing FIG. 4 and FIG. 5, FIG. 4 shows anchor 100 in an open configuration before main plate 104 and backer plate 108 are brought together by tightening screws 112. FIG. 5 shows anchor 100 in a closed configuration after main plate 104 and backer plate 108 are brought together by tightening screws 112. As shown in FIG. 4, backer plate 108 is passed through vehicle wall aperture 126. Screws 112 are inserted through orifices of main plate 104 and backer plate 108, and screws 112 engage with press in nuts 114. As screws 112 are tightened, backer plate 108 is actuated to move towards vehicle wall 124. Continued tightening of screws 112 brings backer plate 108 against vehicle wall 124 and results in anchor 100 clamping down on vehicle wall 124 via main plate 104 and backer plate 108 (FIG. 5). Backer plate 104 can include backer plate orifices 109 (FIG. 8) to allow passage of screws 112. In one embodiment, anchor 100 can include one or more spacers 115 to facilitate retaining rivet nut 116, and to facilitate clamping vehicle wall 124 without causing significant bending or damage to vehicle wall 124. Rivet nut 116 can be configured to engage with bolt 130.

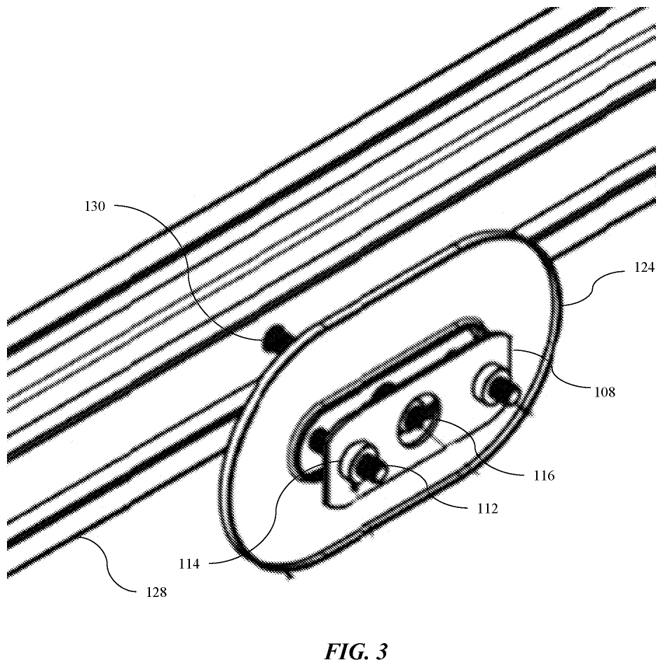

Referencing FIG. 3 again, in one embodiment railing 128 can be secured to anchor 100 via bolt 130. Railing 128 can then be configured to secure and support any desired objects, such as cabinets, for example.

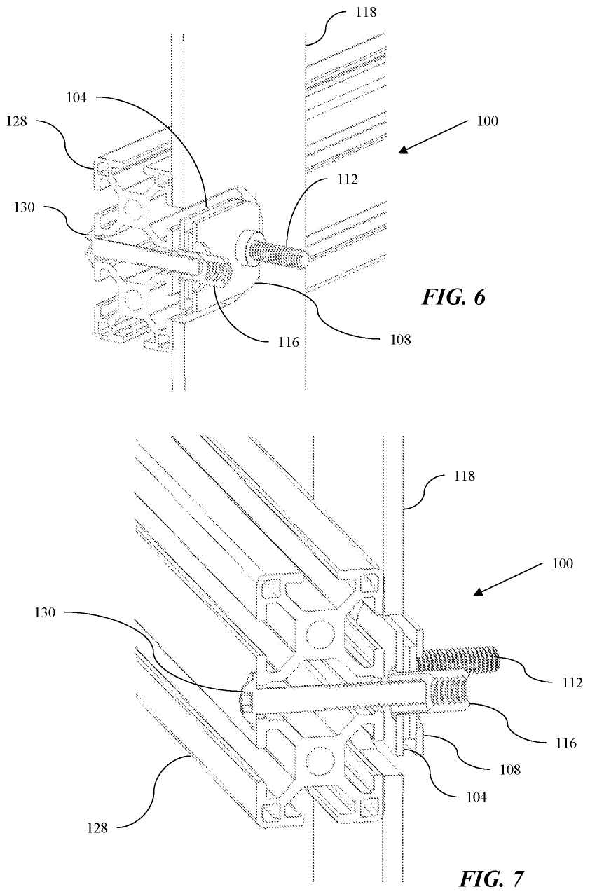

Referencing FIG. 6 and FIG. 7, in one embodiment, anchor 100 can be used to secure wall paneling 118 to a vehicle wall (FIG. 4, FIG. 5). In some embodiments, anchor 100 is clamped to the vehicle wall, and wall paneling 118 is secured between anchor 100 and railing 128. Bolt 130 passes through a hole in railing 128, through orifice 120 (FIG. 1) of main plate 104 and screws into press nut 116 of anchor 100. In certain embodiments, anchor 100 and railing 128 are configured to facilitate attaching wall paneling 118 to a vehicle wall without permanent and/or cumbersome alterations of the vehicle wall, taking advantage of (for example) pre-cut factory holes in the wall of the vehicle. Additionally, railing 128 can be available on wall paneling 118 to facilitate the hanging of other furniture, such as cabinets for example.

Referencing FIG. 8 and FIG. 9, in some embodiments, custom bracket 132 can be coupled to railing 128 by, for example, suitable rail bolts or screws (not shown). In one embodiment, custom bracket 132 is configured to be removably attachable to railing 128, and to receive and secure shelf 134. In one embodiment, custom bracket 132 can include bracket holes or slots 133 for facilitating the coupling of custom bracket 132 to railing 128. Shelf 134 can be configured to couple to and/or support, for example, cabinet panel 136.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the present embodiment is not limited to what has been particularly shown and described hereinabove. A variety of modifications and variations are possible in light of the above teachings without departing from the following claims.

1. An anchor assembly comprising:
a main plate;
a backer plate operatively coupled to the main plate;
at least one press nut coupled to the backer plate;
a rivet nut;
at least one screw for engaging the press nut and actuating the backer plate to move toward the main plate to thereby facilitate the clamping of an object between the main plate and the backer plate;
wherein the main plate comprises a rivet orifice configured to receive and retain the rivet nut;
wherein the main plate comprises at least one screw orifice configured to allow the at least one screw to pass there through;
wherein the backer plate comprises a rivet opening configured to allow the rivet nut to pass there through; and
wherein the backer plate comprises at least one screw opening configured to allow the at least one screw to pass there through and to engage with the at least one press nut.

2. The anchor assembly of claim 1, wherein the anchor assembly is configured to facilitate a placing of the anchor assembly in a cutout of a wall of a vehicle.

3. The anchor assembly of claim 2, wherein the anchor assembly is configured to facilitate a placing of the anchor assembly in a factory cutout cutout of a wall of a vehicle.

4. The anchor assembly of claim 2, further comprising a railing configured to removably couple to the main plate.

5. The anchor assembly of claim 4, further comprising a bolt for coupling the railing to the main plate.

6. An anchor assembly comprising:
a main plate comprising:
a main plate rivet hole configured to receive and retain a rivet nut;
two main plate screw holes configured to allow screws to pass there through;
a backer plate comprising:
a backer plate rivet hole configured to allow a rivet nut to pass there through;
two backer plate screw holes configured to allow screws to pass there through;
two press nuts coupled to the backer plate, each press nut aligned with a backer plate screw hole;
a rivet nut placed and retained in the main plate rivet hole, the rivet nut further passing through the backer plate rivet hole; and
two screws configured to pass through the two main plate screw holes and the two backer plate screw holes, the two screws further configured to engage the press nuts and to facilitate moving the backer plate toward the main plate to thereby facilitate the clamping of an object between the main plate and the backer plate.

7. The anchor assembly of claim 6, wherein the anchor assembly is configured to clamp to a factory cutout of a wall of a vehicle.

8. The anchor assembly of claim 7, further comprising a bolt configured to engage with the rivet nut.

9. The anchor assembly of claim 8, further comprising a railing, wherein the railing comprises a hole configured to receive the bolt.

10. A system for facilitating the attachment of interior furnishings in a vehicle, the system comprising:
an anchor configured to removably couple to a wall of a vehicle, the anchor comprising a rivet nut;
a bolt configured to engage with the rivet nut; and
a railing having a bolt hole to allow the bolt to pass there through.

11. The system of claim 10, wherein the anchor further comprises a main plate for supporting the rivet nut.

12. The system of claim 11, wherein the anchor further comprises a backer plate configured to cooperate with the main plate to clamp the wall of the vehicle between the main plate and the backer plate.

13. The system of claim 12, wherein the anchor further comprises press nuts coupled to the backer plate.

14. The system of claim 13, further comprising screws configured to engage with the press nuts.

15. The system of claim 14, wherein the anchor is configured to be placed in a factory cutout of the wall of the vehicle so that installation of the interior furnishings does not require making cutouts in the wall of the vehicle.

16. The system of claim 15, further comprising a bracket configured to facilitate the attachment of furnishings to the railing.
